(19) United States
(12) Patent Application Publication
(10) Pub. No.: US 2018/0056998 A1
(43) Pub. Date: Mar. 1, 2018

(54) System and Method for Multi-Vehicle Path Planning Technical Field

(71) Applicant: Mitsubishi Electric Research Laboratories, Inc., Cambridge, MA (US)

(72) Inventors: Mouhacine Benosman, Boston, MA (US); Srikumar Ramalingam, Cambridge, MA (US); Ulugbek Kamilov, Cambridge, MA (US)

(73) Assignee: Mitsubishi Electric Research Laboratories, Inc., Cambridge, MA (US)

(21) Appl. No.: 15/249,571

(22) Filed: Aug. 29, 2016

(51) Int. Cl. B60W 30/095; G08G 1/00; G05D 1/02; B60W 30/09; G08G 1/16

(52) U.S. Cl. CPC B60W 30/0956; G08G 1/22; G05D 1/0212; B60W 30/09; G08G 1/163; B60W 2550/408; B60W 2720/103; B60W 2720/24; B60W 2520/06; B60W 2550/14; B60W 2720/106; B60W 2750/40; B60W 2750/308; B60W 2600/00

(57) ABSTRACT

A method generates a time-series signal indicative of a variation of the environment in vicinity of the vehicle with respect to a motion of the vehicle and determines, using the time-series signal, a trajectory of the vehicle to a location different from a current location of the vehicle, the trajectory of the vehicle is a function of time. The method transmits the trajectory of the vehicle to a remote vehicle and controls a motion of the vehicle according to the trajectory of the vehicle.

### TECHNICAL FIELD

The present invention relates generally to controlling vehicles and more particularly to predictive control of different vehicles.

### BACKGROUND

Vehicle collisions are often caused when a driver cannot see or is unaware of an oncoming object. For example, a tree may obstruct a driver's view of oncoming traffic at an intersection. The driver has to enter the intersection with no knowledge whether another vehicle may be entering the same intersection. After entering the intersection, it is often too late for the driver to avoid an oncoming vehicle that has failed to properly yield.

There are other situations where a vehicle is at risk of a collision. For example, a pileup may occur on a busy freeway. A vehicle traveling at 60 miles per hour, or faster, may come upon the pileup with only have a few seconds to react. These few seconds are often too short an amount of time to avoid crashing into the other vehicles. Because the driver is suddenly forced to slain on the brakes, other vehicles in back of the driver's vehicle may possibly crash into the rear end of the driver's vehicle.

It is sometimes difficult to see curves in roads. For example, at night or in rainy, snowy or foggy weather it can be difficult to see when a road curves to the left of right. The driver may then focus on the lines in the road or on the lights of a vehicle traveling up ahead. These driving practices are dangerous, since sudden turns, or other obstructions in the road, may not be seen by the driver.

A vehicle-to-vehicle (V2V) system relates to real-time co-operative communications among vehicles. These systems are directed at traffic management, collision warning, and collision avoidance. Such systems can extend a host vehicle's range of awareness of surrounding environmental conditions by providing relevant information regarding the status of traffic in addition to any safety related events occurring in proximity to the neighboring vehicles.

For example, U.S. Pat. No. 8,229,663 describes a V2V communication system including a controller of the host vehicle that uses the information sensed by different vehicles to monitor surrounding the vehicles. Such a V2V communication system increases the quality and reliability of information about a current state of a vehicle.

However, the current state of the vehicle is not always suited for prediction of the motion of the vehicles over the future time horizon.

### SUMMARY

Some embodiments appreciate that a vehicle-to-vehicle (V2V) system for real-time co-operative communications among vehicles can increases the quality and reliability of information sensed by a vehicle using the information received from a remote vehicle. Such a V2V communication system increases the quality and reliability of information about a current state of a vehicle and/or current state of the remote vehicle. However, due to unpredictability of road conditions and multitude of road maneuvers and actions, the current state of the remote vehicle is not always indicative of its subsequent state. For example, the change in a direction of the velocity signaled by the remote vehicle may indicate the urgent need to switch the lines or a maneuver within the line. The change of a magnitude of the velocity may indicate the need to stop or temporary adjustment of the speed.

Some embodiments are based on realization that future intentions of the remote vehicles can be clues for path planning of the host vehicle, referred herein just as a vehicle. To that end, some embodiments use V2V communication, not to or not only to exchange the information about what each vehicle is sensing at the present time, but also to exchange the information about what the vehicle is ‘thinking’ of doing in the near future, i.e., its planned action.

Some embodiments can be illustrated using the following analogy. Imagine driving down the freeway, and a driver in front of you calls you on your cell and tells you what maneuver, such as slowing down or changing lanes, she is going to make in the near future, e.g., in the next minute. With this information, you can plan a safer trajectory for your car. Such a phone call is impractical, but some embodiments are based on realization that when the remote vehicle determines its motion trajectory predictively, the result of that prediction can be shared with other vehicles. To that end, some embodiments share a trajectory of the vehicle to a location different from a current location of the vehicle with a remote vehicle and/or receive the trajectory planned by the remote vehicle to update the trajectory of the vehicle. In such a manner, a group of vehicles can benefit from this overall knowledge of future desired trajectories of each other to plan safer and more efficient maneuvers.

As used herein, the trajectory of the vehicle is a function of time. For example, the trajectory of the vehicle includes one or combination of a velocity profile of the vehicle defining values of the velocity of the vehicle for the entire length of the trajectory and an acceleration profile of the vehicle defining values of the acceleration of the vehicle for the entire length of the trajectory.

One embodiment is based on additional recognition that the trajectories exchanged between vehicles should be feasible, i.e., should satisfy time and spatial constraints on a position of the vehicle, but does not have to consider dynamics of the vehicle, i.e., constraints on the motion of the vehicle. To that end, the exchanged trajectory can be a referenced trajectory indicating an intention of a vehicle rather than actual trajectory the vehicle can follow. Such a reference trajectory is usually easier to calculate and to update than the actual motion trajectory, which can save some computational resources of the vehicle.

Accordingly, one embodiment discloses a method for controlling a vehicle. The method includes generating a time-series signal indicative of a variation of the environment in vicinity of the vehicle with respect to a motion of the vehicle; determining, using the time-series signal, a trajectory of the vehicle to a location different from a current location of the vehicle, wherein the trajectory of the vehicle is a function of time; transmitting the trajectory of the vehicle to a remote vehicle; and controlling a motion of the vehicle according to the trajectory of the vehicle. At least some steps of the method are performed by a processor.

Another embodiment discloses a vehicle including at least one sensor for sensing the environment in vicinity of the vehicle to generate a time-series signal indicative of a variation of the environment with respect to a motion of the vehicle; at least one processor for determining, using the time-series signal, a trajectory of the vehicle to a location different from a current location of the vehicle, wherein the trajectory of the vehicle is a function of time; and a transceiver for transmitting the trajectory of the vehicle to a remote vehicle and for receiving a trajectory of the remote vehicle; wherein the processor updates the trajectory of the vehicle using the trajectory of the remote vehicle and controls motion of the vehicle to follow the trajectory.

Yet another embodiment discloses a non-transitory computer readable storage medium embodied thereon a program executable by a processor for performing a method, which includes generating a time-series signal indicative of a variation of the environment in vicinity of the vehicle with respect to a motion of the vehicle; determining, using the time-series signal, a trajectory of the vehicle to a location different from a current location of the vehicle, wherein the trajectory of the vehicle is a function of time; transmitting the trajectory of the vehicle to a remote vehicle; and controlling a motion of the vehicle according to the trajectory of the vehicle.

### BRIEF DESCRIPTION OF THE DRAWINGS

FIG. 1A is an example of a vehicle-to-vehicle (V2V) communication and planning according to one embodiment;

FIG. 1B is a block diagram of a method for controlling a vehicle according to one embodiment;

FIG. 1C is a block diagram of a method for controlling a vehicle according to one embodiment;

FIG. 2 is system architecture for a host vehicle and a remote vehicle according to one embodiment;

FIG. 3 is a block diagram of a low level control system for controlling a vehicle according to one embodiment;

FIG. 4 is a schematic of a multi-vehicle platoon shaping for accident avoidance scenario according to one embodiment;

FIG. 5 is a schematic of a multi-vehicle platoon shaping for accident avoidance scenario according to another embodiment;

FIG. 6 is a schematic representation of platoon formation of multiple vehicles according to one embodiment;

FIG. 7 is a graph representation of different modes of operation of the vehicles according to one embodiment;

FIG. 8 is a schematic of a committed mode of the vehicle according to one embodiment; and

FIG. 9 is a schematic of a planning mode of the vehicle according to one embodiment.

### DETAILED DESCRIPTION

Some embodiments consider multi-vehicle autonomy and path planning. A set of vehicles communicate among themselves and help each other to have a better knowledge of the road conditions, e.g., obstacles, and/or communicate to each other their future maneuvers intensions, e.g., their planned trajectories in space and time, so that the vehicles can plan their trajectories based on their knowledge of the road conditions and the future action of the vehicles around them.

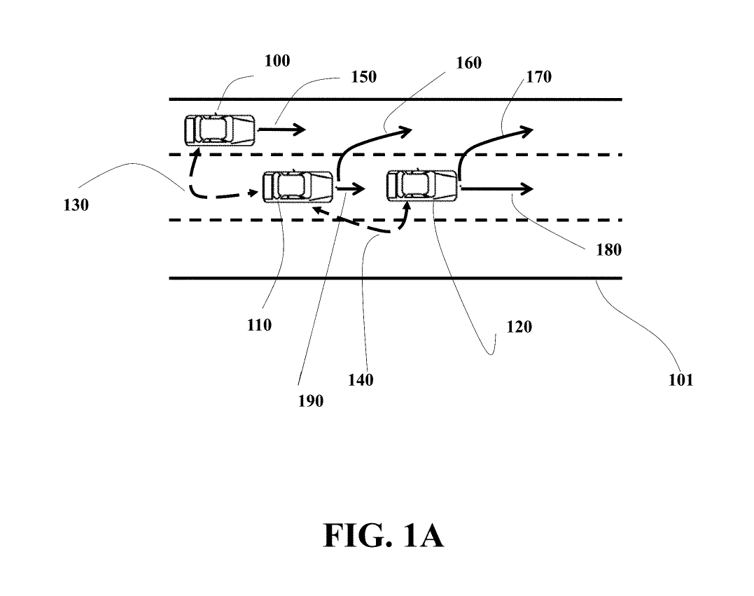

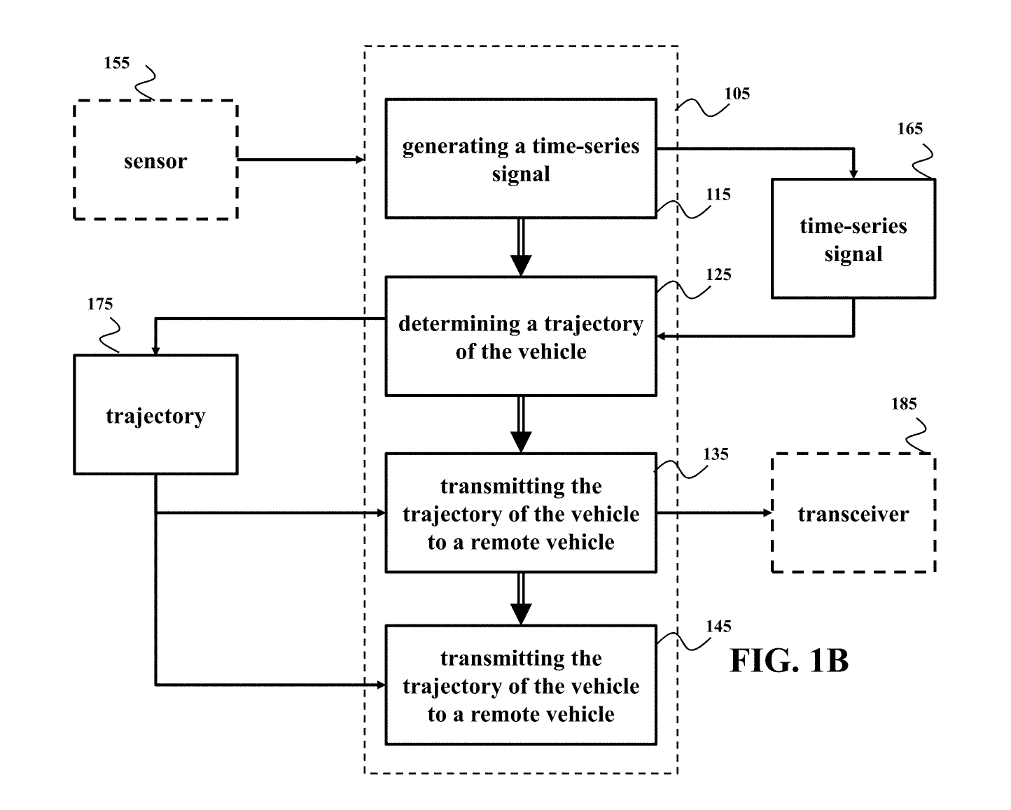

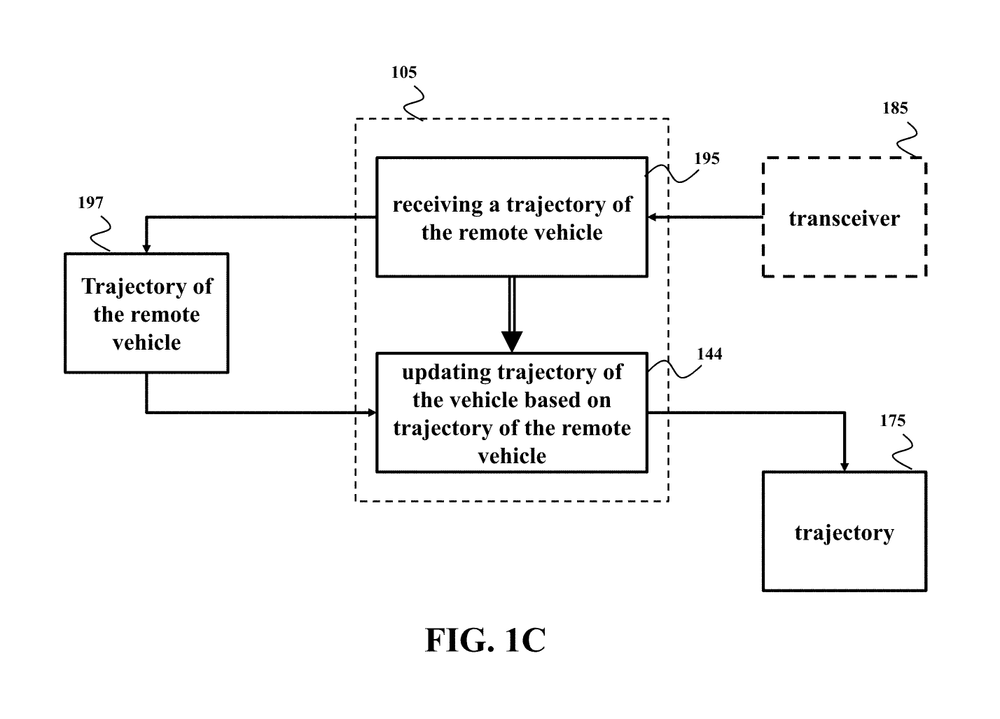

FIG. 1A shows an example of a vehicle-to-vehicle (V2V) communication and planning according to one embodiment. As used herein, each vehicle can be any type of moving transportation system, including a passenger car, a mobile robot, or a rover. For example, the vehicle can be an autonomous or semi-autonomous vehicle.

In this example, multiple vehicles 100, 110, 120, are moving on a given freeway 101. Each vehicle can make many motions. For example, the vehicles can stay on the same path 150, 190,180, or can change paths (or lanes) 160, 170. Each vehicle has its own sensing capabilities, e.g., LIDAR's, cameras, etc. Each vehicle has the possibility to transmit and receive 130, 140 information with its neighboring vehicles and/or can exchange information indirectly through other vehicles. For example, the vehicles 100 and 180 can exchange information through a vehicle 110. With this type of communication network, the information can be transmitted over a large portion of the freeway or highway 101.

Some embodiments are configured to address the following scenario. For example, the vehicle 120 wants to change its path and chooses option 170 in its path planning. However, at the same time vehicle 110 also chooses to change its lane and wants to follow option 160. In this case, the two vehicles might collide, or at best vehicle 110 will have to execute and emergency brake to avoid colliding with vehicle 120. This is where the present invention can help. To that end, some embodiments enable the vehicles to transmit not only what the vehicles sense at the present time instant t, but also, additionally or alternatively, transmit what the vehicles are planning to do at time t+delta_t.

In the example of FIG. 1A, the vehicle 120 informs of its plan to change lane to vehicle 110 after planning and committing to execute its plan. Thus the vehicle 110 knows that in delta_t time interval the vehicle 120 is planning to make a move to its left 170. Accordingly, the vehicles 110 can select the motion 190 instead of 160, i.e., staying on the same lane.

FIG. 1B shows a block diagram of a method for controlling a vehicle according to one embodiment. The method can be implemented using a processor 105 of the vehicle operatively connected to at least one sensor 155 for sensing the environment in vicinity of the vehicle and a transceiver 185 for, e.g., exchanging information with at least one remote vehicle.

Using the measurements of the sensor 155, the processor 105 generates 115 a time-series signal 165 indicative of a variation of the environment in vicinity of the vehicle with respect to a motion of the vehicle. Examples of the sensor include LIDAR's, color and depth cameras. Next, the processor determines 125, using the time-series signal, a trajectory 175 of the vehicle to a location different from a current location of the vehicle. The trajectory 175 of the vehicle is a function of time. For example, the trajectory 175 can include one or combination of a velocity profile of the vehicle defining values of the velocity of the vehicle for the entire length of the trajectory and an acceleration profile of the vehicle defining values of the acceleration of the vehicle for the entire length of the trajectory.

The processor 105 transmits 135, using a transceiver 185, the trajectory 175 of the vehicle to a remote vehicle and controls 145 a motion of the vehicle according to the trajectory of the vehicle. In such a manner, the remote vehicle can use the trajectory 175 in determining its own trajectory and controlling its own motion.

Additionally, or alternatively, the remote vehicle can also determine its trajectory and transmit that predicted trajectory to the vehicle. In such a manner, the vehicle and the remote vehicle can mutually update their trajectory in dependence on each other.

FIG. 1C shows a block diagram of a method for controlling a vehicle according to one embodiment. The processor 105 receives 195 a trajectory 197 of the remote vehicle to a location distant from a current location of the remote vehicle and updates the trajectory 175 of the vehicle based on the trajectory 197 of the remote vehicle. For example, one embodiment modifies the time-series signal using the trajectory of the remote vehicle and updates the trajectory of the vehicle based on the modified time-series signal.

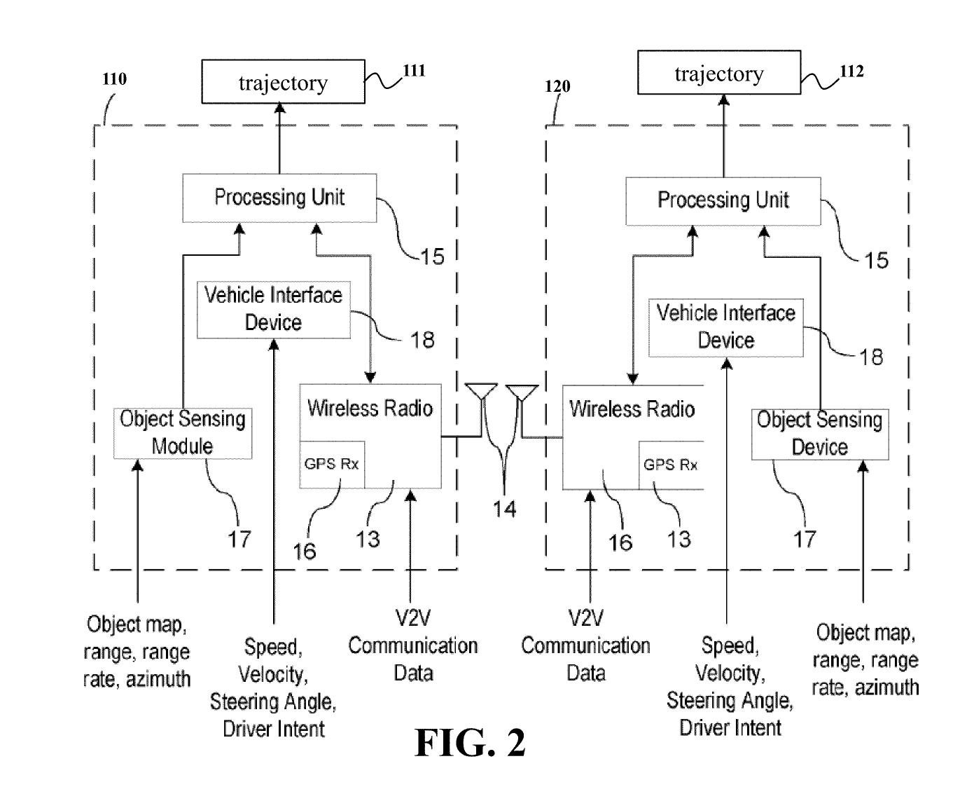

FIG. 2 shows the system architecture for the host vehicle, e.g., the vehicle 110 and a respective remote vehicle, e.g., the vehicle 120, according to one embodiment. The host vehicle 110 and the respective remote vehicle 120 (e.g., remote vehicles) are each equipped with a wireless radio 13 that includes a transmitter and a receiver (or transceiver) for broadcasting and receiving the wireless messages via an antenna 14. The host vehicle 110 and respective remote vehicle 120 further include respective processing units or processors 15 for processing the data received in the wireless message or other transmitting devices such as a global positioning system (GPS) receiver 16. Alternatively, the wireless radio may also function as a GPS receiver. Each vehicle can include an object detection module 17 for collecting data received form object detection sensors. The system can further include a vehicle interface device 18 for collecting information including, but not limited to, speed, braking, yaw rate, acceleration, and steering wheel angle.

A GPS utilizes a constellation of satellites that transmit signals which enable the GPS receiver 18 of a vehicle to determine its location, speed, direction, and time. GPS data for a respective vehicle of the V2V communication network can be broadcast as part of the wireless message for identifying the location of the transmitting vehicle. This allows the respective processing unit 15 of the host vehicle 110 to evaluate the message contents in light of the remote vehicle's position for assessing the relevance of a respective condition to the host vehicle 110.

The object detection module 17 receives data from the object detection devices that include, but are not limited to, radar-based detection devices, vision-based detection devices, and light-based detection devices. Examples of such devices may include radar detectors (e.g., long range and short range radars), cameras, and Lidar devices, stereo vision. Each respective sensing system detects or captures an image in the respective sensors field-of-view. The field-of-view is dependent upon the direction in which the object detection sensors are directed. Some of the data obtained through V2V communications may not be obtainable by the object detection devices, and vice versa. By combining the data obtained from both systems, a comprehensive awareness of the vehicle surroundings may be obtained in addition to correcting errors that commonly occur with each sensing system.

Based on collected information, the processors 15 of the vehicle 110 and/or remote vehicle 120 can determine its desired trajectories 111 and 112. In addition, the wireless radio 13 can be used to exchange information about trajectories 111 and 112 between the vehicles 110 and 120. Upon receiving the exchanged trajectories, the processor 15 of the vehicle 110 and/or vehicle 120 can update their corresponding trajectories.

One embodiment is based on additional recognition that the trajectories exchanged between vehicles should be feasible, i.e., should satisfy time and spatial constraints on a position of the vehicle, but does not have to consider dynamics of the vehicle, i.e., constraints on the motion of the vehicle. To that end, the exchanged trajectory can be a referenced trajectory indicating an intention of a vehicle rather than actual trajectory the vehicle can follow. Such a reference trajectory is usually easier to calculate and to update than the actual motion trajectory, which can save some computational resources of the vehicle.

For example, the trajectory 175 of the vehicle is a reference trajectory that satisfies time and spatial constraints on a position of the vehicle. However, the vehicle or the processor of the vehicle further determines a motion trajectory that tracks the reference trajectory while satisfying constraints on a motion of the vehicle and controls the motion of the vehicle to follow the motion trajectory. Notably, such a trajectory planning and vehicle control can be implemented using a variety of path planning and low level motion control methods for autonomous and/or semi-autonomous vehicles.

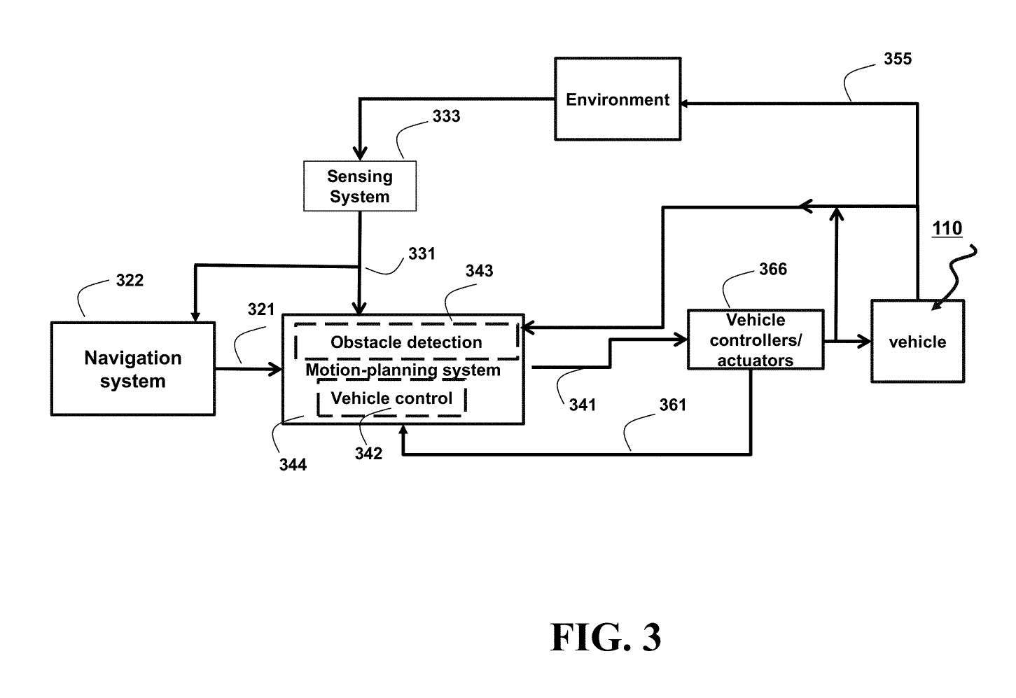

FIG. 3 shows a block diagram of a low level control system for controlling a vehicle 110 according to one embodiment. The vehicle can be any type of moving vehicle equipped with an autonomous system. As one example, the vehicle 110 can be a four-wheel passenger car. The control system includes a navigation system 322 for determining an initial location and a target location of the vehicle. For example, the navigation system 322 can include GPS and/or an inertial measurement unit (IMU).

For example, the initial location can be the current location as determined by the GPS. The target location can be determined in response to information 331 from the sensing system 333 including at least one sensor for detecting an obstacle on the predicted path of the vehicle. The information 331 can also include the trajectories received from neighboring vehicles providing their next motions that the neighboring vehicles are planning to execute.

The control system also includes a motion-planning system 344 for computing a future motion of the vehicle. For example, the motion-planning system determines the motion of the vehicle by optimizing a cost function. For instance, the cost function can penalize the deviation from nominal norms of at least some parameters of the state of the vehicle, such as acceleration, velocity, lateral displacement. In another embodiment, the motion is computed by optimizing a cost function determined from the desired driver motion or the desired fuel consumption, etc.

In addition to the initial and the target locations, the motion-planning system 344 receives information 331 about the surroundings 355, such as obstacles, or illegal areas for the vehicle. The information 331 can be received from the sensors 333. The information about the environment can be represented as a map. The motion-planning system 340 can also receive information 361 about the vehicle motion from the vehicle-control units 366. The information can include a state of the vehicle, such as position, heading, velocity, and is received either from hardware or software.

The motion-planning system 344 determines a reference trajectory that satisfies time and spatial constraints on a position of the vehicle and determines a motion trajectory 341 that tracks the reference trajectory while satisfying constraints on a motion of the vehicle. The motion at least includes a path, velocity, and orientation/heading, but can also include further entities, such as rotational velocities, accelerations, and steering, brake, and engine torques.

The motion trajectory 341 is used as an input to the low level vehicle controllers 366 to compute vehicle commands, such as steering, brake, and throttle. Those commands are submitted to the actuators of the vehicle to move the vehicle according to the predicted motion 341. The motion-planning system can include models 342 of the vehicle controllers 366 for computing the motion trajectory 341. Therefore, the trajectory computed by the motion-planning system 344 can accurately be executed by the vehicle-control system 366. For example, the vehicle control system 166 includes a steering controller, a break controller and a throttle controller, and the motion-planning system includes model emulating the operations of those controllers.

Some embodiments appreciate the benefits of mutually updating the trajectory of the vehicle and the trajectory of the remote vehicle in dependence on each other. For example, one embodiment updates the trajectory of the vehicle and the trajectory of the remote vehicle to form a platoon formation including the vehicle and the remote vehicle and controls the motion of the platoon formation.

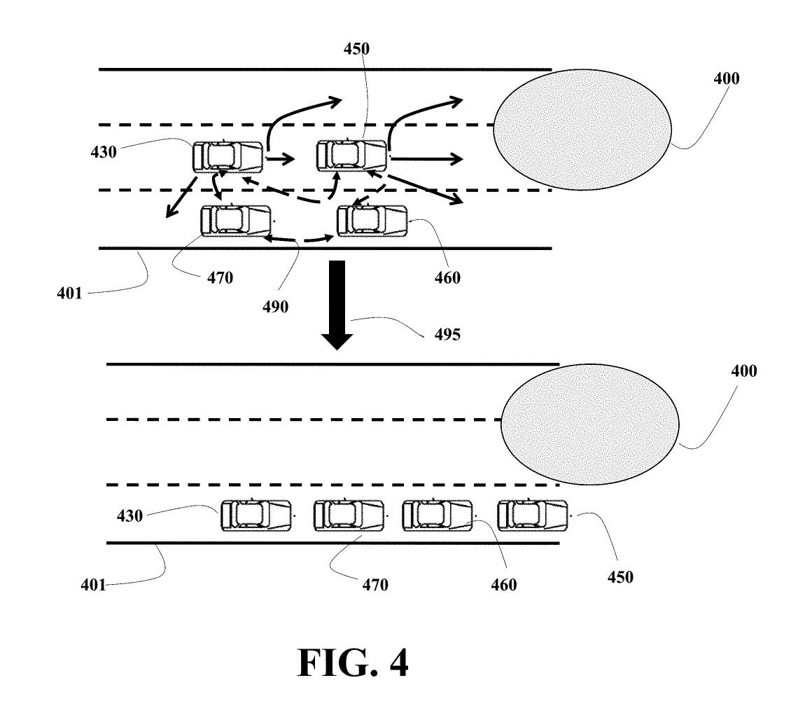

FIG. 4 is a schematic of a multi-vehicle platoon shaping for accident avoidance scenario according to one embodiment. For example, consider a group of vehicles 430, 470, 450, 460, moving on a freeway 401. Consider now that suddenly, there is an accident ahead of the vehicle platoon in the zone 400. This accident renders the zone 400 unsafe for the vehicles to move. The vehicles 420, 460 sense the problem for example with a camera, and communicate this information to the vehicles 430, 470. The platoon then executes a distributed optimization algorithm, e.g., formation keeping multi-agent algorithm, which selects the best shape of the platoon to avoid the accident zone 400 and also to keep the vehicle flow uninterrupted. In this illustrative example, the best shape of the platoon is to align and form a line 495, avoiding the zone 400.

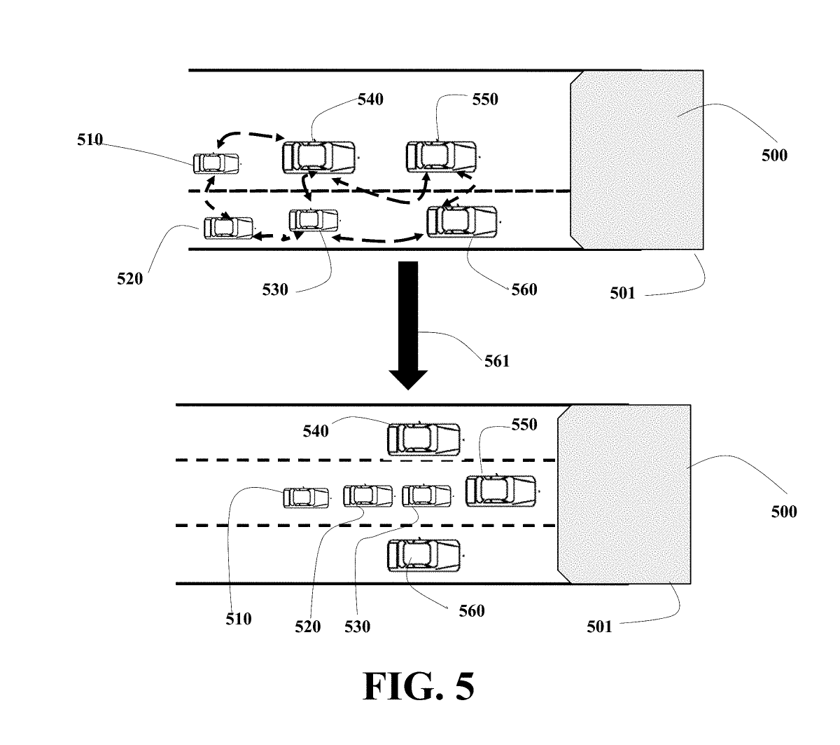

FIG. 5 is a schematic of a multi-vehicle platoon shaping for accident avoidance scenario according to another embodiment. In this example, a group of vehicles 510, 540, 550, 520, 530, 560 are moving on a given highway 501. Those vehicles are of different sizes. For instance, the group includes the big vehicles 540, 550, 560, and smaller frame vehicles 510, 520, 530, e.g., trucks vs. small family cars.

If a strong wind gust is detected, e.g., by the front vehicles 550, 560 or leader vehicles, those vehicles transmit this information to the others. The group then decide using a multi-agent shape optimization algorithm, which can be run in a distributed way on each vehicle, to re-shape or to form the platoon in a form of a triangle, such that the bigger heavier vehicles are facing the wind conditions and the smaller vehicles are inside the triangle, hiding behind the bigger cars, to be able to go safely through the wind gusts as a group with an optimal efficiency, for example in terms of fuel consumption.

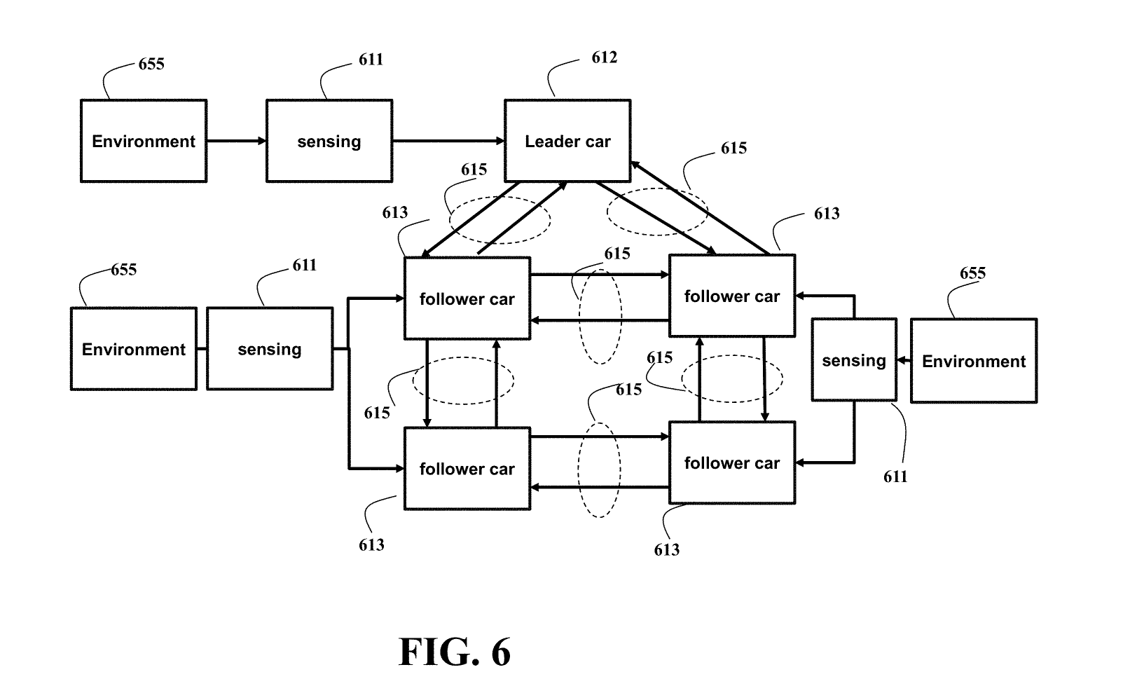

FIG. 6 shows a schematic representation of platoon formation of multiple vehicles according to one embodiment. This embodiment uses a multi-agents formation control method to form the platoon. For example, of in the exemplar multi-agents control method of FIG. 6, each agent is a vehicle 612, 613. The leader vehicle 612 senses 611 the environment 655, and then transmits its sensed data, for example detecting a large vehicle in front using its camera sensor, to the neighboring vehicles 613, using local communication between neighboring vehicles 615. These local communications 615 are bi-directional, which means that the neighboring vehicles 613, also called follower vehicles can also transmit 615, their sensed 611 data from the environment 655. Each vehicle then runs a local formation control algorithm to calculate what is the optimal distance and angle to keep with respect to its neighboring vehicle. For example, the formation control can be based on Lyapunov potential field methods, or on distributed optimal control, or on distributed MPC methods.

Some embodiments of the invention synchronize in time the trajectory of the vehicle and the trajectory of the remote vehicle by exchanging a synchronization token. Those embodiments are based on recognition that such synchronization allows to mutually update the trajectories.

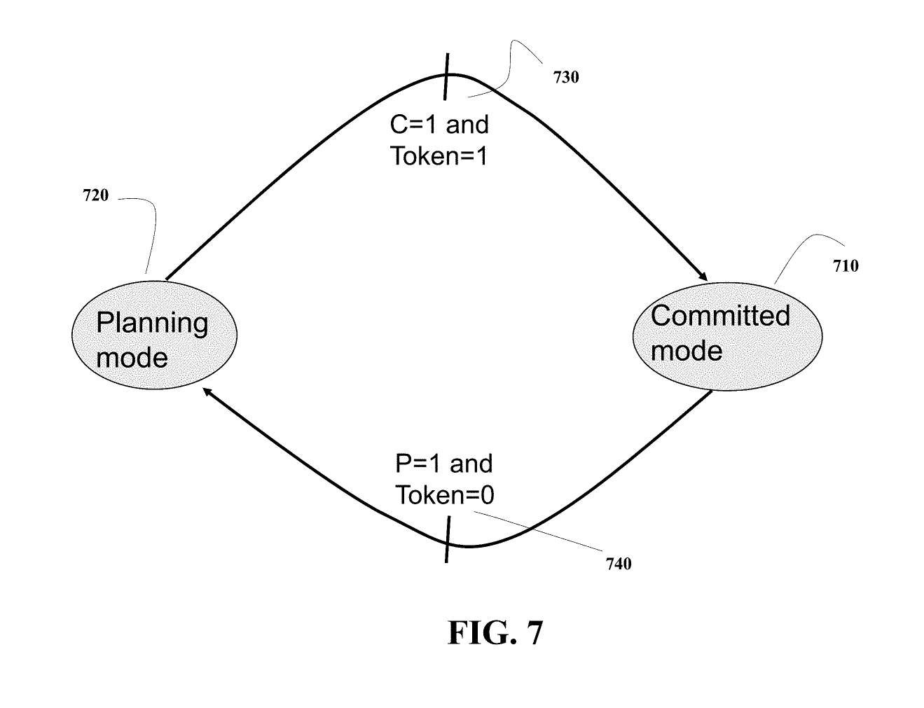

FIG. 7 shows a graph representation of different modes of operation of the vehicles according to one embodiment. For example, the embodiment determines the trajectory during a planning mode 720 while maintaining a current velocity, switches to a committed mode 710 by transmitting the synchronization token 730, and controls the motion according the trajectory during the committed mode 710. The vehicle can also further acquire 740 a synchronization token to switch back to the planning mode.

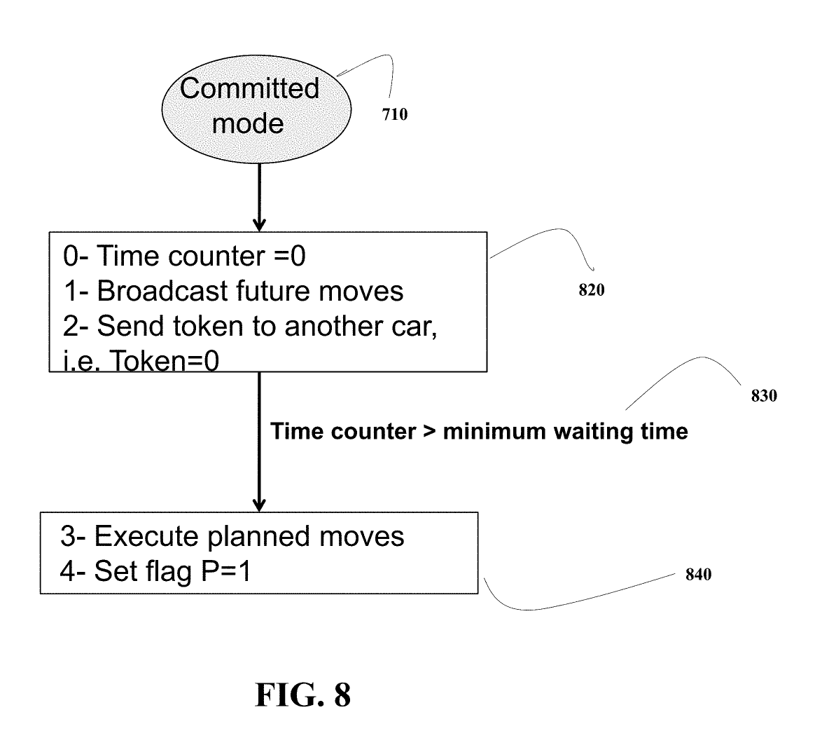

FIG. 8 shows a schematic of a committed mode 710 of the vehicle according to one embodiment. For example, the vehicle sets 820 a time counter to zero and broadcasts its trajectory, e.g., broadcast an intention to move to the left lane following a given time-profile. Also, the vehicle releases the token to another car, i.e., Token=0 for this car. Next after the time counter has exceeded a given minimum waiting time (for the other vehicles to process this information), the vehicle controls its motion according to the trajectory, and, e.g., sets its flag P to 1.

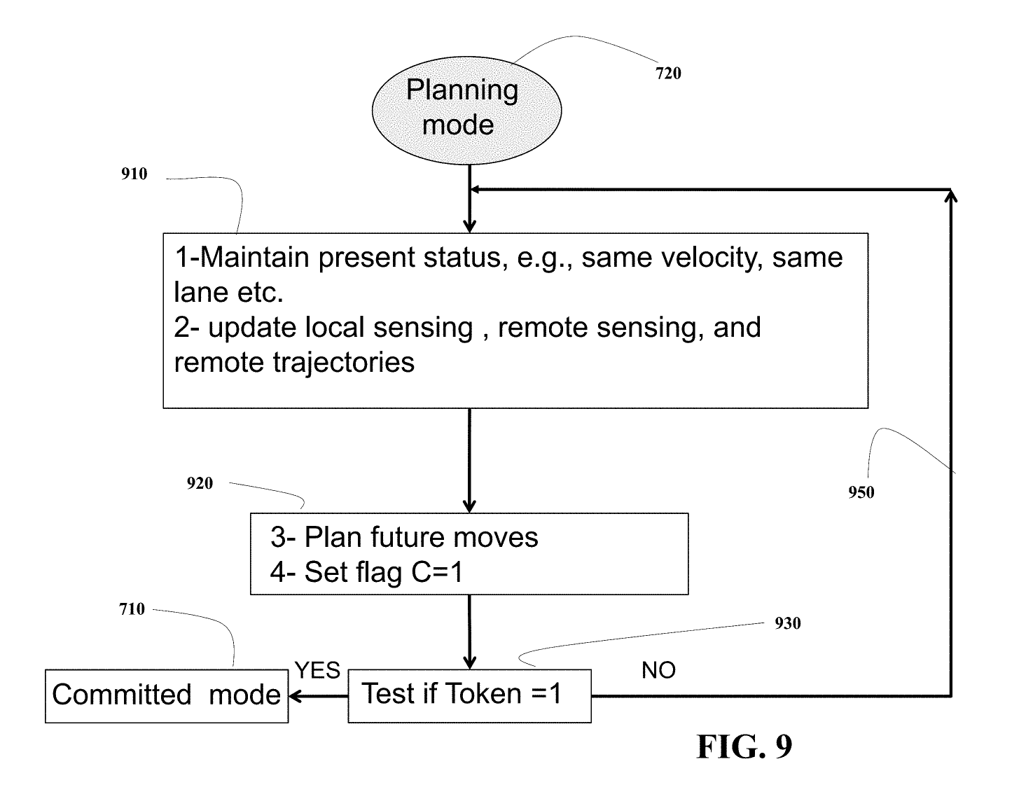

FIG. 9 shows a schematic of a planning mode 720 of the vehicle according to one embodiment. In this mode, the vehicle maintains 910 its present status, e.g., maintains the same velocity, and updates its time-series data using one or combination of the local sensing performed by sensors of the vehicle, remote sensing performed by the sensors of the remote vehicle, and trajectory planned by the remote vehicle. The vehicle determines 920 its trajectory from the time-series data and sets its flag C to one. Next, the vehicle tests 930 for the possession of the Token. If vehicle is in possession of the token, the vehicle moves into the committed mode 710, otherwise, the vehicle remains 950 in the planning mode 720 to execute its planned moves later after the token can be acquired.

In one embodiment, the synchronization Token is arbitrarily and randomly fast between the vehicles, such that each vehicle has the chance to quickly execute its planned moves. In alternative embodiments, the tokens are transmitted and/or received upon the request.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Also, the embodiments of the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A method for controlling a vehicle, comprising:
generating a time-series signal indicative of a variation of the environment in vicinity of the vehicle with respect to a motion of the vehicle;
determining, using the time-series signal, a trajectory of the vehicle to a location different from a current location of the vehicle, wherein the trajectory of the vehicle is a function of time;
transmitting the trajectory of the vehicle to a remote vehicle; and
controlling a motion of the vehicle according to the trajectory of the vehicle, wherein at least some steps of the method are performed by a processor.

2. The method of claim 1, further comprising:
receiving a trajectory of the remote vehicle to a location distant from a current location of the remote vehicle, wherein the trajectory of the remote vehicle is a function of time; and
updating the trajectory of the vehicle based on the trajectory of the remote vehicle.

3. The method of claim 2, further comprising:
modifying the time-series signal using the trajectory of the remote vehicle; and
updating the trajectory of the vehicle based on the modified time-series signal.

4. The method of claim 3, wherein the trajectory is updated while the motion of the vehicle is controlled according to the trajectory.

5. The method of claim 2, further comprising:
synchronizing in time the trajectory of the vehicle and the trajectory of the remote vehicle by exchanging a synchronization token.

6. The method of claim 5, further comprising:
determining the trajectory during a planning mode while maintaining a current velocity;
switching to a committed mode by transmitting the synchronization token; and
controlling the motion according the trajectory during the committed mode.

7. The method of claim 2, further comprising:
mutually updating the trajectory of the vehicle and the trajectory of the remote vehicle in dependence on each other.

8. The method of claim 7, wherein the mutually updating comprises:
updating the trajectory of the vehicle and the trajectory of the remote vehicle to form a platoon formation including the vehicle and the remote vehicle; and
controlling the motion of the platoon formation.

9. The method of claim 1, wherein the trajectory of the vehicle includes one or combination of a velocity profile of the vehicle defining values of the velocity of the vehicle for the entire length of the trajectory and an acceleration profile of the vehicle defining values of the acceleration of the vehicle for the entire length of the trajectory.

10. The method of claim 1, wherein the trajectory of the vehicle is a reference trajectory that satisfies time and spatial constraints on a position of the vehicle, further comprising:
determining a motion trajectory that tracks the reference trajectory while satisfying constraints on a motion of the vehicle; and
controlling the motion of the vehicle to follow the motion trajectory.

11. The method of claim 1, wherein the processor is operatively connected to at least one sensor for sensing the environment in vicinity of the vehicle, and wherein the processor is operatively connected to a transceiver for transmitting the trajectory of the vehicle to the remote vehicle and for receiving the trajectory of the remote vehicle, wherein the processor updates the trajectory of the vehicle using the trajectory of the remote vehicle and controls the motion of the vehicle to follow the trajectory.

12. A vehicle, comprising:
at least one sensor for sensing the environment in vicinity of the vehicle to generate a time-series signal indicative of a variation of the environment with respect to a motion of the vehicle;
at least one processor for determining, using the time-series signal, a trajectory of the vehicle to a location different from a current location of the vehicle, wherein the trajectory of the vehicle is a function of time;
a transceiver for transmitting the trajectory of the vehicle to a remote vehicle and for receiving a trajectory of the remote vehicle;
wherein the processor updates the trajectory of the vehicle using the trajectory of the remote vehicle and controls motion of the vehicle to follow the trajectory.

13. The vehicle of claim 12, wherein the trajectory is updated while the vehicle is moving according to the trajectory.

14. The vehicle of claim 12, wherein the processor synchronizes the trajectory of the vehicle and the trajectory of the remote vehicle by exchanging a synchronization token with the remote vehicle using the transceiver.

15. The vehicle of claim 12, wherein the processor of the vehicle and a processor of the remote vehicle mutually update the trajectory of the vehicle and the trajectory of the remote vehicle in dependence on each other.

16. The vehicle of claim 15, wherein the mutually update includes updating the trajectory of the vehicle and the trajectory of the remote vehicle to form a platoon formation and controlling the motion of the platoon formation.

17. The vehicle of claim 12, wherein the trajectory of the vehicle includes one or combination of a velocity profile of the vehicle defining values of the velocity of the vehicle for the entire length of the trajectory and an acceleration profile of the vehicle defining values of the acceleration of the vehicle for the entire length of the trajectory.

18. The vehicle of claim 12, wherein the trajectory of the vehicle is a reference trajectory that satisfies time and spatial constraints on a position of the vehicle, further comprising:
a motion controller for determining a set of control commands to track the reference trajectory while satisfying constraints on a motion of the vehicle; and
a set of actuators for controlling the motion of the vehicle according to the set of control commands.

19. A non-transitory computer readable storage medium embodied thereon a program executable by a processor for performing a method, the method comprising:
generating a time-series signal indicative of a variation of the environment in vicinity of the vehicle with respect to a motion of the vehicle;
determining, using the time-series signal, a trajectory of the vehicle to a location different from a current location of the vehicle, wherein the trajectory of the vehicle is a function of time;
transmitting the trajectory of the vehicle to a remote vehicle; and
controlling a motion of the vehicle according to the trajectory of the vehicle.

20. The medium of claim 18, wherein the method further comprises:
receiving a trajectory of the remote vehicle to a location distant from a current location of the remote vehicle, wherein the trajectory of the remote vehicle is a function of time; and
updating the trajectory of the vehicle based on the trajectory of the remote vehicle.
